(19) United States
(12) Patent Application Publication
(10) Pub. No.: US 2014/0230309 A1
(43) Pub. Date: Aug. 21, 2014

(54) ILLUMINATING OUTRIGGER TIP

(71) Applicant: Nautical Illuminations, LLC, Narragansett, RI (US)

(72) Inventors: Alex Petrucci, JR., Narragansett, RI (US); Alex Petrucci, SR., Narragansett, RI (US); Steven Knott, Warwick, RI (US)

(73) Assignee: Nautical Illuminations, LLC, Narragansett, RI (US)

(21) Appl. No.: 13/957,644

(22) Filed: Aug. 2, 2013

Related U.S. Application Data
(60) Provisional application No. 61/767,413, filed on Feb. 21, 2013.

(51) Int. Cl. A01K 87/00; A01K 91/18

(52) U.S. Cl. CPC A01K 87/007; A01K 91/18
USPC 43/17.5

(57) ABSTRACT

An outrigger tip attachable to an outrigger pole comprises a translucent elongate main body including a proximal end portion having an opening for accessing an inner cavity, and the proximal end portion of the translucent elongate main body being sized and configured for engaging an open end of the outrigger pole. A light emitting diode assembly is sized and configured for engaging the inner cavity through the opening on the proximal end portion of the translucent elongate main body. The light emitting diode assembly comprises one or more light emitting diodes, an input device for sending signals to control the light emitting diodes, a controller in connection with the light emitting diodes, and the controller being structured and disposed for receiving signals from the input device and delivering an output signal to the light emitting diodes, and a battery connecting member structured and disposed for connecting to a power source.

### BACKGROUND OF THE INVENTION

This patent application is based on provisional patent application Ser. No. 61/767,413 filed on Feb. 21, 2013.

### FIELD OF THE INVENTION

The present invention relates to outriggers for boats and, more particularly, an illuminating outrigger tip for use in combination with outrigger poles on boats.

### DISCUSSION OF THE RELATED ART

Outrigger sets are a series of poles that represent part of a boat's rigging system and generally extend beyond the side of the boat. For fishing applications, outriggers permit boats to troll more lines in the water without tangling the lines. Moreover, outriggers are useful for stabilizing the main hull to prevent the boat from capsizing in poor weather conditions. Each outrigger generally includes a removable end tip that is attachable to the outrigger by a snap lock or set screw.

There exists a need for an illuminating outrigger tip that is adapted for use with traditional outrigger poles on boats and which can be controlled using a wireless remote control.

### OBJECTS AND ADVANTAGES OF THE INVENTION

Considering the foregoing, it is a primary object of the present invention to provide an outrigger tip that is illuminable.

It is a further object of the present invention to provide an illuminating outrigger tip that is wirelessly controlled.

It is a further object of the present invention to provide an illuminating outrigger tip that is adapted for attachment with a traditional outrigger.

It is yet a further object of the present invention to provide an illuminating outrigger tip that is configurable to automatically change color in response to user input.

These and other objects and advantages of the present invention are more readily apparent with reference to the detailed description and accompanying drawings.

### SUMMARY OF THE INVENTION

The present invention is directed to an illuminating outrigger tip including an elongate main body adapted for secured attachment to a distal end of an outrigger pole. The main body is made out of a translucent or transparent material, such as transparent plastic. In one embodiment, the main body includes an inner cavity sized and configured for engaged receipt of a light emitting diode (LED) assembly, which may be powered via solar power (in combination with a 6V battery), or wired connection to a battery power source (e.g. 12V battery), or a combination thereof. In a preferred embodiment, the transparent main body is comprised of a high quality ultraviolet (UV) resistant plastic or other suitable material that will resist fading and discoloration when exposed to sunlight and weather elements. The light emitted by the LED assembly is visible through the main body. The LED assembly is configurable to automatically change color and/or light pattern or change in response to user input. The illuminating outrigger tips can be integrated with a music device, such as a sound system on a boat, wherein the light color and/or light pattern automatically changes in response to the music output sequence.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of the illuminating outrigger tip of the present invention;

FIG. 2 is a perspective view of a boat with illuminating outrigger tips of the present invention installed on opposite facing poles of an outrigger assembly;

FIG. 3 is an isolated perspective view of the illuminating outrigger tip of the present invention installed on the distal end of an outrigger pole;

FIG. 4 is a top plan view, shown in cross-section, of the illuminating outrigger tip of the present invention;

FIG. 5 is a front elevational view of a remote control for operating the light emitting diode assembly;

FIG. 6 is an isolated top plan view, shown in partial cross-section, of the illuminating outrigger tip of the present invention and illustrating the light emitting diode assembly;

FIG. 7 is an isolated perspective view of an outrigger including the illuminating outrigger tip of the present invention;

FIG. 8 is an isolated perspective view of the spreaders of an outrigger pole and illustrating illuminating tips on the spreaders of the outrigger assembly; and

FIG. 9 is an isolated perspective view of the rear side of a boat and illustrating a flag pole having an illuminating tip.

Like reference numerals refer to like referenced parts throughout the several views of the drawings.

### DETAILED DESCRIPTION OF THE PREFERRED EMBODIMENTS

Referring to the several views of the drawings, the illuminating outrigger tip of the present invention is shown according to several embodiments and is generally indicated as 10.

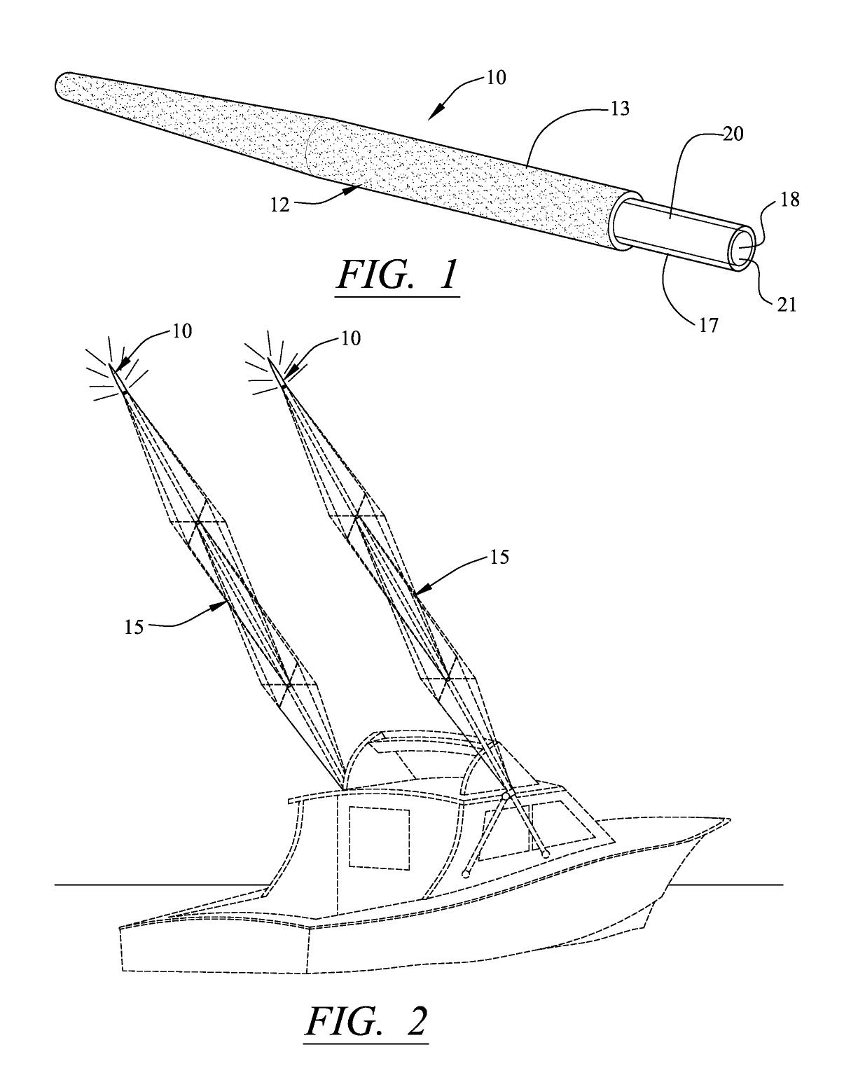

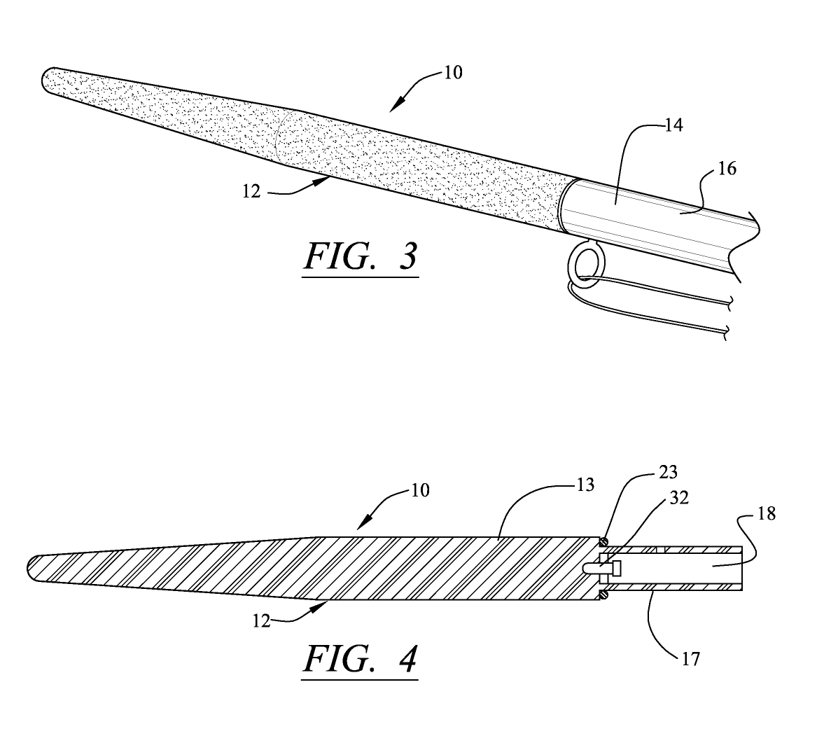

Referring to FIGS. 1-4, the illuminating outrigger tip 10 includes an elongate main body 12 adapted for secured attachment to a distal end 14 of an outrigger pole 16 of an outrigger assembly 15. In a preferred embodiment, the proximal end portion 17 of the elongate main body 12 is sized to snuggly engage the open-ended channel at the distal end 14 of the outrigger pole 16, as shown in the accompanying drawings. Specifically, the proximal end portion 17 has a reduced exterior dimension (e.g. reduced out diameter) relative to the adjacent section of the main body 12. In one embodiment, the proximal end portion 17 of elongate main body 12 includes an opening for receiving a set screw 19 (FIG. 6) for securing the illuminating outrigger tip 10 to the outrigger pole 16 in the engaged position. The main body 12 is made out of a translucent or transparent material, such as transparent plastic. In one embodiment, the main body 12 includes an inner cavity 18 sized and configured for engaged receipt of a light emitting diode (LED) assembly 20 (FIG. 6).

In a preferred embodiment, the transparent main body 12 is comprised of a high quality ultraviolet (UV) resistant plastic or other suitable material that will resist fading and discoloration when exposed to sunlight and weather elements. The light emitted by the LED assembly 20 is visible through the main body 12. The outer-facing surface 13 of the transparent material forming the elongate main body 12 may be formed with one of a variety of different surface finishes, including a textured surface finish or a polished surface finish.

Specifically referring to FIG. 4, the inner cavity 18 extends between an inner-facing side of the elongate main body 12 and the open end 21 at the reduced diameter proximal end portion 17 of the elongate main body 12. In one embodiment, the main body 12 includes an inner cavity 18 sized and configured for engaged receipt of a light emitting diode (LED) assembly 20 (FIG. 6), which may be powered via solar power (in combination with a 6V battery), a wired connection to a battery power source 37 (e.g. 12V battery), or a combination thereof. In one embodiment, the proximal end portion 17 includes an o-ring 23 for sealing the connection between the transparent main body 12 and the distal end 14 of an outrigger pole 16 when the proximal end portion 17 engages the open-ended channel at the distal end 14 of the outrigger pole 16.

In one embodiment, the LED assembly 20 is configurable to automatically change color and/or light pattern or change in response to user input. The illuminating outrigger tips 10 can further be integrated (wired connection or wireless connection) with a music device, such as a sound system on a boat, wherein the light color and/or light pattern automatically changes in response to the music output.

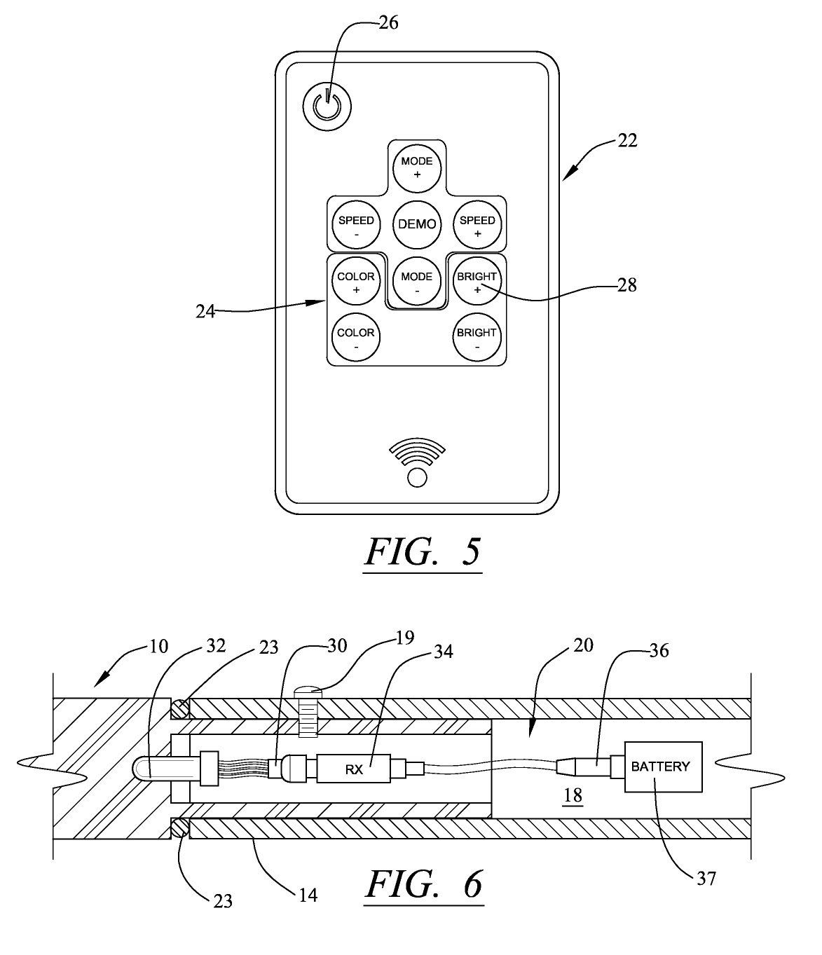

Referring to FIG. 5, the LED assembly 20 is wirelessly operable using a remote control 22, which includes a control panel 24 for operating the illuminating outrigger tip 10 and, more specifically, the color and light pattern emitted by the LED assembly 20 and one or more LEDs 32 (FIG. 6) using ON/OFF switch 26 and one or more operating buttons 28 for controlling LED features including, but not limited to, brightness, speed, color, and light pattern mode.

Referring to FIG. 6, the LED assembly 20 includes a wire harness 30 configured for connection with one or more LEDs 32, a radio frequency (RF) receiver 34 and a battery connecting member 36. The LED assembly 20 is sized and configured for engaged receipt within inner cavity 18 of the elongate main body 12. The RF receiver 34 is configured to receive wireless signals from the remote control 22 and send a corresponding signal for controlling operation of the one or more LEDs 32, including, but not limited to, the brightness, speed, color, and light pattern mode of the LEDs 32.

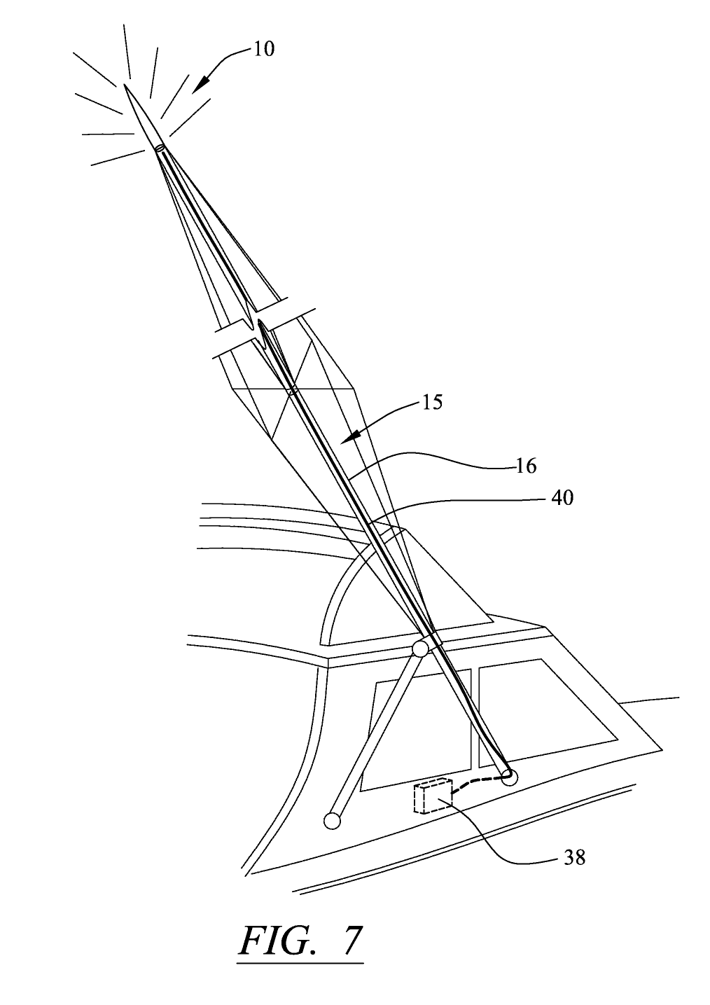

Referring to FIG. 7, a further embodiment of the illuminating outrigger tip 10 is shown, wherein the LED assembly 20 is controlled via a wired connection. A control box 38 is connected to the LED assembly 20 by an electrical wire 40 extending through the length of the outrigger pole 16. The control box 38 includes a control panel for operating the illuminating outrigger tip 10 and, more specifically, the color and light pattern emitted by the LED assembly 20 and one or more LEDs 32 using an ON/OFF switch and one or more operating buttons for controlling LED features including, but not limited to, brightness, speed, color, and light pattern mode. The LED assembly 20 may be powered via solar power (in combination with a 6V battery), a wired connection to a battery power source 37 (e.g. 12V battery), or a combination thereof.

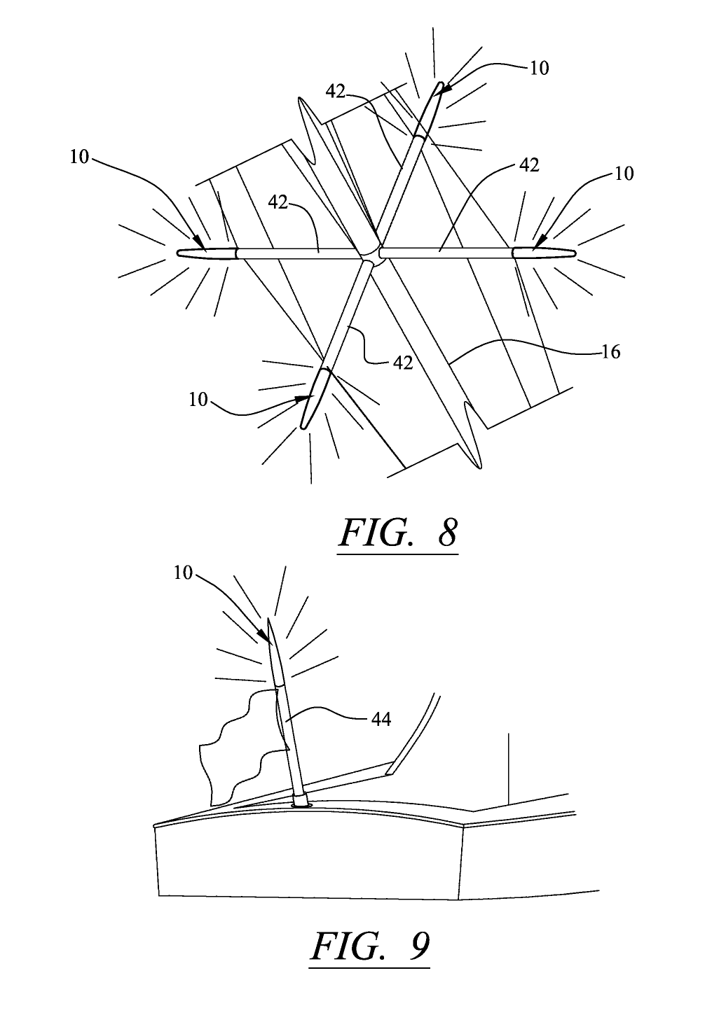

Referring to FIGS. 8 and 9, further embodiments of the illuminating outrigger tip 10 are shown. Specifically, FIG. 8 illustrates an elongate main body 12 adapted for attachment to the distal end of a spreader 42 in connection with an outrigger pole 16. FIG. 9 illustrates an elongate main body 12 adapted for attachment to the distal end of a flag pole 44. For each of the embodiments shown in FIGS. 8 and 9, the illuminating outrigger tips 10 can be wirelessly controlled or, alternatively, controlled via a wired connection.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. An outrigger tip attachable to an outrigger pole and said outrigger tip comprising:
a translucent elongate main body including a proximal end portion having an opening for accessing an inner cavity, and the proximal end portion of said translucent elongate main body having a reduced exterior dimension for engaging an open end of the outrigger pole; and
a light emitting diode assembly being sized and configured for engaging the inner cavity through the opening on the proximal end portion of said translucent elongate main body, and said light emitting diode assembly comprising:
one or more light emitting diodes;
an input device for sending signals to control the output of said one or more light emitting diodes;
a controller in connection with said one or more light emitting diodes, and said controller being structured and disposed for receiving signals from said input device and delivering an output signal to said one or more light emitting diodes; and
a battery connecting member structured and disposed for connecting to a power source.

2. The outrigger tip as recited in claim 1 wherein said input device is a remote control structured and disposed for wireless sending signals to said controller.

3. The outrigger tip as recited in claim 1 wherein said input device is a control box in wired connection with said controller for sending signals to said controller.

4. The outrigger tip as recited in claim 1 further comprising an o-ring on the proximal end portion of said translucent elongate main body for promoting sealed engagement between said translucent elongate main body and the outrigger pole.

5. The outrigger tip as recited in claim 1 wherein said controller is structured and disposed for receiving output signals from a music device, and wherein the output of said one or more light emitting diodes is configured for corresponding with the output signals from the music device.

6. The outrigger tip as recited in claim 1 wherein said input device is configured for operating the color output of said one or more light emitting diodes.

7. The outrigger tip as recited in claim 1 wherein said input device is configured for operating the brightness output of said one or more light emitting diodes.

8. The outrigger tip as recited in claim 1 wherein said input device is configured for operating the light pattern output of said one or more light emitting diodes.

9. An illuminating outrigger tip comprising:
a translucent elongate main body including a proximal end portion having an opening for accessing an inner cavity, and the proximal end portion of said translucent elongate main body having a reduced exterior dimension for engaging an open end of a pole; and
a light emitting diode assembly being sized and configured for engaging the inner cavity through the opening on the proximal end portion of said translucent elongate main body, and said light emitting diode assembly comprising:
one or more light emitting diodes;
an input device for sending signals to control the output of said one or more light emitting diodes;
a controller in connection with said one or more light emitting diodes, and said controller being structured and disposed for receiving signals from said input device and delivering an output signal to said one or more light emitting diodes; and
a battery connecting member structured and disposed for connecting to a power source.

10. The illuminating outrigger tip as recited in claim 9 wherein said translucent elongate main body is sized and configured for engaging an open end of a spreader pole.

11. The illuminating outrigger tip as recited in claim 9 wherein said translucent elongate main body is sized and configured for engaging an open end of a flag pole.

12. The illuminating outrigger tip as recited in claim 9 wherein said input device is a remote control structured and disposed for wireless sending signals to said controller.

13. The illuminating outrigger tip as recited in claim 9 wherein said input device is a control box in wired connection with said controller for sending signals to said controller.

14. The outrigger tip as recited in claim 9 further comprising an o-ring on the proximal end portion of said translucent elongate main body for promoting sealed engagement between said translucent elongate main body and the outrigger pole.

15. The illuminating outrigger tip as recited in claim 9 wherein said controller is structured and disposed for receiving output signals from a music device, and wherein the output of said one or more light emitting diodes is configured for corresponding with the output signals from the music device.

16. The illuminating outrigger tip as recited in claim 9 wherein said input device is configured for operating the color output of said one or more light emitting diodes.

17. The illuminating outrigger tip as recited in claim 9 wherein said input device is configured for operating the brightness output of said one or more light emitting diodes.

18. The illuminating outrigger tip as recited in claim 9 wherein said input device is configured for operating the light pattern output of said one or more light emitting diodes.
